(19) United States
(12) Patent Application Publication
(10) Pub. No.: US 2011/0155188 A1
(43) Pub. Date: Jun. 30, 2011

(54) WHEEL GUIDE RAIL AND CAR WASHING SYSTEM

(75) Inventor: Georg Wimmer, Affing (DE)

(73) Assignee: WASHTEC HOLDING GMBH, Augsburg (DE)

(21) Appl. No.: 13/055,336

(22) PCT Filed: Jul. 23, 2009
(86) PCT No.: PCT/EP09/59520

§ 371 Date: Mar. 10, 2011

(30) Foreign Application Priority Data
Jul. 24, 2008 (DE) 202008009959.5

(51) Int. Cl. B60S 3/04

(52) U.S. Cl. 134/123

(57) ABSTRACT

The invention relates to a wheel guide rail (9; 10) for a car wash system, comprising a machine flank (9c; 10c) that points upward from a wash system floor (B) in the installed state and runs along a direction of travel (F) of a vehicle to be treated, and a car wash system comprising treatment devices (1, 1′, 3, 3′) that can travel along a direction of travel (F) for a vehicle to be treated, a pair of wheel guide rails (10, 10′) disposed at the wash system floor (B) between the treatment devices (1, 1′, 3, 3′) and running in the direction of travel and at a distance from one another perpendicular to the direction of travel (F), said guide rails delimiting a lateral travel range (4) for the vehicle. The object of facilitating a safe, risk-free and damage-free treatment and cleaning of vehicles is met by the invention by a wheel guide rail (9; 10) in which the machine flank (9c; 10c) is designed such that it is tilted upward toward the vehicle (4), and by a car wash system comprising such wheel guide rails.

The invention relates to a wheel guide rail according to the preamble of claim 1 and also to a car wash system according to the preamble of claim 12.

A wheel guide rail named above follows from DE 21 04 049 A. The towing device for vehicles in that publication, especially for washing systems, has two guide rails between which the wheels of one side of a vehicle are moved. The guide rails have a flat crosspiece that is arranged essentially perpendicular to the floor of the car wash system and on whose upper end a longitudinal rod with a circular cross section is arranged.

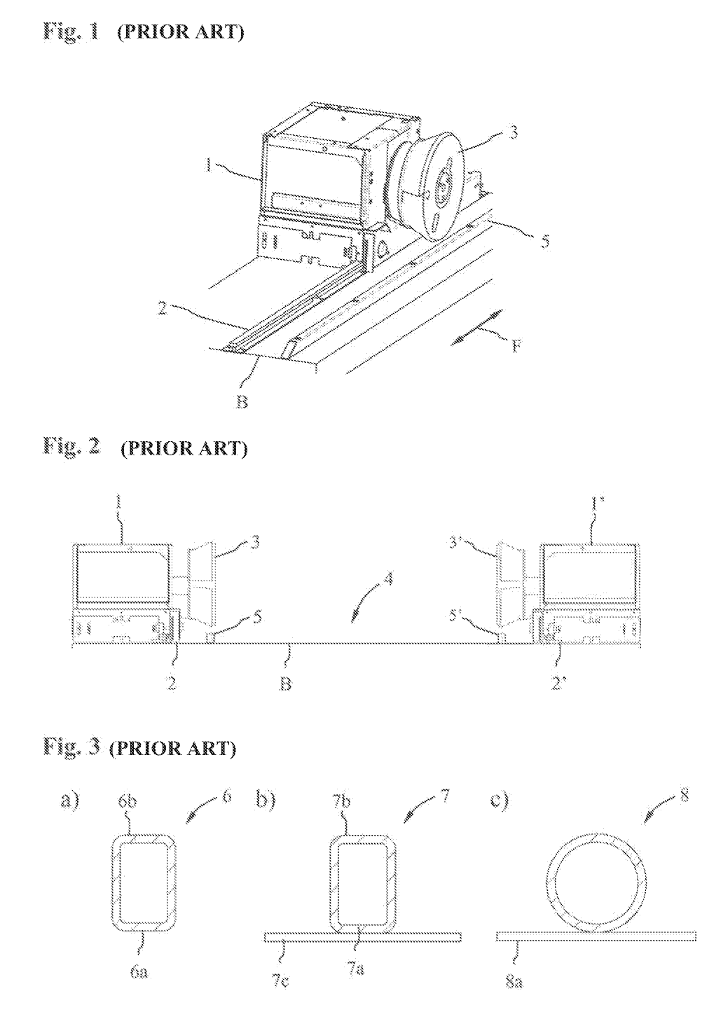

FIGS. 1-5 show additional wheel guide rails according to the class for car wash systems. In FIG. 1, a left pedestal foot 1 of a not-shown gantry post of a portable washing gantry of a car wash system is shown that can be moved in a direction of travel F along a travel rail 2 on a floor B of a washing system. On the pedestal foot 1, there is a schematically shown tire washer 3 that points in the direction of a tire of a vehicle to be washed. In order to be able to drive the vehicle to be washed into a travel range 4 of the car wash system as much as possible in the center with respect to the gantry posts 1, 1′ indicated in FIG. 2 by the pedestal feet, in addition to the drive rails 2, 2′, wheel guide rails 5, 5′ offset toward the travel range 4 are mounted on the floor of the car wash system. As follows especially from FIG. 2, the two wheel guide rails 5 and 5′ define the travel range 4 between which the wheels of a vehicle to be washed should move.

FIG. 3 shows examples for cross sections of known wheel guide rails. A wheel guide rail 6 shown in FIG. 3 a) consists of a rectangular steel hollow profile, wherein the edges are slightly rounded. In a base 6a and an end side 6b of the wheel guide rail 6, passage drill holes are formed at certain intervals, wherein, by means of these holes, the wheel guide rail 6 can be screwed on the floor B of the washing system. FIG. 3 b) shows another known wheel guide rail 7. There, the wheel guide rail from FIG. 3a was welded onto a floor plate or floor threshold 7c, so that no passage drill holes are needed in an end side 7b and a base 7a of the wheel guide rail 7. The wheel guide rail 7 is then mounted by screws of the floor plate or the floor threshold 7c on the floor B of the washing system. A known wheel guide rail 8 shown in FIG. 3 c) also has a floor plate or floor threshold 8a for mounting on the floor B of the washing system, while the guide part of the wheel guide rail 8 is produced from a steel tube with a circular cross section.

The known wheel guide rails 5, 5′ are used to ensure during the entry of the vehicle that the driver positions the vehicle as centered as possible with respect to the side treatment devices, in order to have the most equal travel path possible for treatment devices acting on the vehicle from the side. Thus, for example, the wheel washers 3 and 3′ indicated in FIG. 2 can be moved out from the position away from the vehicle shown in the drawing into the extended position for washing the tire rims not shown in FIG. 2. Here, in order to achieve a good washing result, it is desirable to press both with approximately the same contact pressure onto the tire rims, which is then possible primarily when the vehicle is positioned exactly in the middle relative to the gantry posts 1, 1′. A non-centered position of the vehicle could have the result that travel paths or ranges of treatment assemblies are not sufficient and therefore insufficient cleaning of the vehicle results. In addition, if the vehicle is driven past the movable washing gantry, the wheel guide rails 5 and 5′ ensure that the vehicle does not project into a region in which there is the risk of a collision with the treatment assemblies or other parts of the washing gantry, for example, the risk of damage to the outside mirrors.

In order to guarantee this guide function, the wheel guide rails 5, 5′ must be so high that the driver of the entering vehicle notices possibly driving against or also over a wheel guide rail 5, 5′, in order to be able to then make counter steering maneuvers. This is not a problem for small, lightweight vehicles with small wheels, because in these vehicles, contact with the typically 60 mm high wheel guide rails 5, 5′ with rectangular cross sections is easily noticed. More and more, however, there are large, heavy vehicles with large vehicle widths and large wheel or tire-rim diameters, for example, 21″ rims in sports cars, all-terrain vehicles, or so-called SUV vehicles. In these vehicles, driving against or over the wheel guide rails 5, 5′ is often not noticed by the driver due to the tire size and the large vehicle weight, so that the vehicles often come to stand off center in the travel range 4 or even on the wheel guide rails 5, 5′. In this way, when the washing gantry moves over the vehicle, projecting vehicle parts, for example, outside mirrors, are often damaged on the affected side of the vehicle. In addition, the cleaning result is made worse, because the vehicle is too far away from the treatment assemblies on the other side of the vehicle. In addition, such large vehicles often have such a large tread width and thus outer wheel spacing that, for old or narrow vehicle washing systems, the wheel guide rails are too close to each other and are always driven against or over.

In small, narrow washing systems, wide vehicles with large tread widths and corresponding spacing of the outsides of the wheels present the problem that these vehicles must drive over the wheel guide rails on one or both sides, in order to be able to enter into the washing systems at all. In order to be able to adapt such car wash systems also to the larger vehicle widths, the wheel guide rails must be shifted outward. For the known wheel guide rails, however, this presents the problem that the distance, for example, between the movable washing gantry 1 shown in FIG. 2 and the wheel guide rails 5, 5′ then becomes too small. This distance is legally stipulated in some countries and equals, for example, in Germany at least 120 mm or less than 10 mm. This stipulation should prevent a person from becoming stuck with a shoe between the foot of the machine 1 and the wheel guide rail 5 during maintenance work or in case of a fault in the washing system, so that, in the worst case, if a vehicle drives against the washing gantry in an undesired way, the foot is squeezed between the wheel guide rail and the travel rail and is passed over by the washing gantry. If the distance equals only less than 10 mm or more than 120 mm, there is no worry of a risk of becoming stuck or jammed. However, if the car wash system is also to be able to be used for the above wide vehicles, on one hand, the wheel guide rails must be shifted outward and, on the other hand, the danger to persons listed above must be prevented.

DE 38 43 643 C2 discloses a towing device for vehicle wheels in automatic car wash systems in which a vehicle wheel is pulled through the automatic car wash system by means of an endlessly circulating traction mechanism. The traction mechanism has circulating chains arranged on both sides of a track for the vehicle wheel to be towed, with movable sliding blocks being arranged at intervals on these chains. In order to prevent the towed wheel from swerving from the track, the sliding blocks are inclined upward away from the vehicle wheel next to the guide track, thus forming a guide funnel. A vehicle wheel leaving the track runs against the sliding blocks and then slides back into the guide track. This construction has an unnecessarily complicated construction for a fixed guide rail and is used exclusively for guiding the vehicle wheel. This construction is neither provided nor suitable as protection for operating personnel walking around the machine-side area, that is, the area remote from the travel range and outside the wheel guide rails.

In order to be able to also recognize the contact of the wheel guide rails 5, 5′ for such large vehicles, in a first approach the height of the wheel guide rail could be increased. This, however, is associated with the disadvantage that for vehicles with small tires or low cross-section tires, not only the rubber tires, but also the rims themselves impact against the wheel guide rails 5, 5′ that are typically made from steel, and are hereby damaged. Especially for the large vehicles named above, due to the large rim diameter, low cross-section tires are often used, so that in connection with the large vehicle width, such vehicles already disproportionately impact the wheel guide rails with their usually expensive rims. The damage to such expensive rims is a big disadvantage for the operators of the car wash system due to high indemnification payments. Higher wheel guide rails would increase these cases even more.

In order to prevent this disadvantage, primarily for low cross-section tires, a second approach to a solution would involve wheel guide rails with smaller constructions. This would have the result, however, that driving against or over the wheel guide rails would no longer be noticed particularly by these large vehicles, so that a good cleaning result would not be achieved and there would also be the risk of damage to other vehicle parts or treatment assemblies of the washing system.

Therefore it is the problem of the present invention to overcome the disadvantages named above and to disclose a wheel guide rail and also a car wash system that make possible a safe, non-dangerous, and damage-free treatment and cleaning of vehicles. In particular, the invention shall reliably prevent, on one hand, damage to vehicle parts of the vehicle to be washed, especially tires or tire rims, and, on the other hand, shall make possible a centered entrance and positioning of the vehicle in the car wash system. Equally, injury to persons shall be reliably excluded.

The invention solves this problem by a wheel guide rail with the features of claim 1 as well as a car wash system with the features of claim 12. Advantageous constructions and preferred refinements of the invention are specified in the subordinate claims.

The wheel guide rail according to the invention is characterized in that the machine flank is constructed so that it is inclined upward towards the travel range in the installed state of the wheel guide rail. Preferably, the machine flank can be arranged on a side of the wheel guide rail facing away from the travel range. If a shoe of a person is located in the region between the wheel guide rail and washing gantry or its travel rails during the washing gantry processing, at most the shoe will be shifted along the wheel guide rail due to the inclination of the machine flank, but will not become jammed. In the best case, the moving washing gantry pushes the shoe together with the leg of the person upward onto the machine flank.

A further inclination angle inclined toward the travel range and formed between the machine flank and the floor of the washing system preferably lies between 25° and 65°. For steeper inclination angles there is again the risk of jamming, while for flatter inclination angles, the wheel guide rail becomes too wide in order to achieve the necessary height of the wheel guide rail.

In one advantageous construction of the wheel guide rail, a wheel guide flank is provided on a side of the wheel guide rail opposite the machine flank, wherein the wheel guide flank is constructed so that it is inclined upward away from the travel range in the installed state of the wheel guide rail. In this way, if tires are driven against the wheel guide rail, first the bottom region of the wheel guide flank is contacted, while the upper region of the wheel guide flank inclined away is still sufficiently far away from the tire and rim of the vehicle, so that damage to the rim itself is reliably avoided even if the tire is driven against the flank hard and if the tire has a small cross section. An inclination angle inclined away from the travel range and formed between the wheel guide flank and a vertical running perpendicular to the floor of the washing system and parallel to the direction of travel, that is, parallel to the wheel guide rail, preferably lies between 5° and 30°. For smaller inclination angles, impact with the rim cannot be reliably prevented and for larger inclination angles, the wheel guide flank is too flat, so that driving against or over the flank can no longer be reliably noticed by the driver.

Advantageously with respect to production, the wheel guide rail can be formed from an elongated hollow profile material, advantageously from [a] steel hollow profile. In order to provide additional protection for sensitive rims and optionally provided distance sensors of the wheel guide rail, a cover made from plastic or rubber, advantageously hard rubber, can be arranged on the wheel guide flank.

An alternative wheel guide rail that is advantageous with respect to production can be formed from a solid material made from plastic or rubber, advantageously hard rubber, wherein damage to sensitive rims is prevented.

In order to simplify the centered positioning, in one advantageous construction of the wheel guide rail at least one distance sensor can be provided for measuring the distance from the wheel guide rail to the outside of a wheel and/or to the side of a vehicle. Here, the inclined wheel guide flank is advantageous, because in this way a large measurement window can be created for the distance sensors.

The wheel guide rails according to the invention can preferably be used in a car wash system according to the invention. In this car wash system, the distance of the wheel guide rails from each other perpendicular to the direction of travel advantageously can be greater than a specified maximum wheel distance. The wheel guide flanks of the wheel guide rails can advantageously point toward the travel range, that is, they are arranged on the side of the vehicle wheels.

Additional details and advantages of the invention are given from the following description of preferred embodiments with reference to the drawings. Shown are:

FIG. 1, a schematic three-dimensional diagram of a cutout of a known car wash system with a movable washing gantry,

FIG. 2, a schematic front view of another cutout of the car wash system from FIG. 1,

FIG. 3, a cross section of three known wheel guide rails,

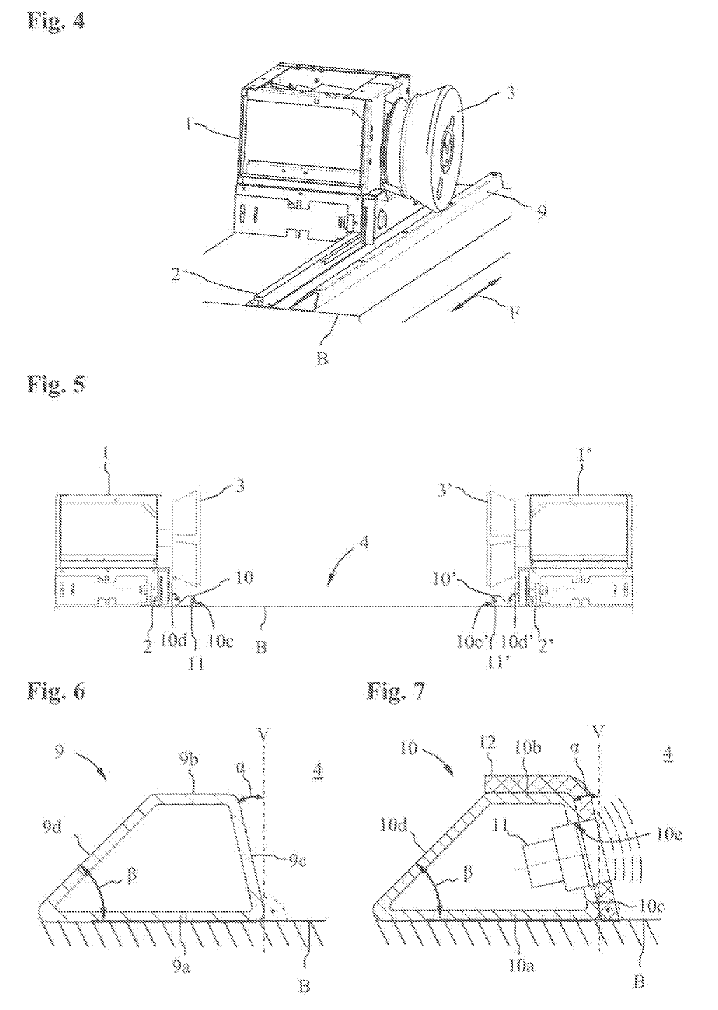

FIG. 4, a schematic three-dimensional diagram of a cutout of a car wash system according to the invention with a movable washing gantry,

FIG. 5, a schematic front view of another cutout of the car wash system from FIG. 4,

FIG. 6, a cross section of a wheel guide rail according to the invention according to a first embodiment,

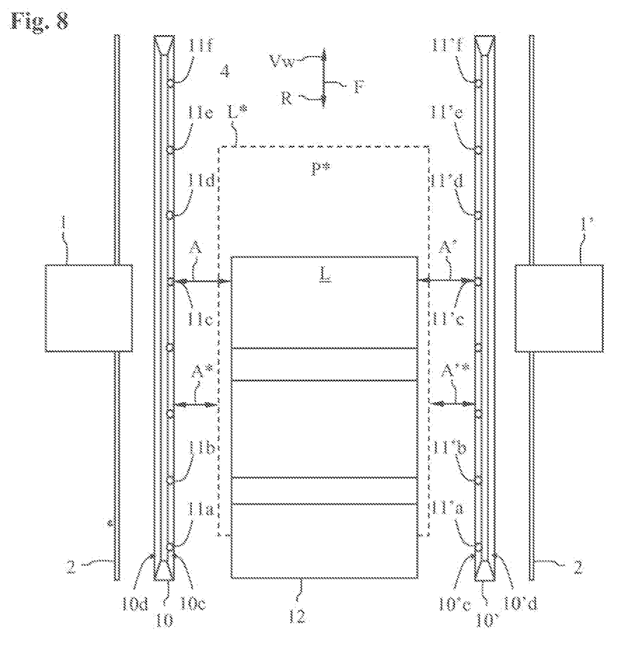

FIG. 7, a cross section through a second embodiment of a wheel guide rail according to the invention,

FIG. 8, a schematic top view of a part of a car wash system according to the invention according to FIGS. 4 and 5.

In FIGS. 6 and 7, cross sections of the wheel guide rails according to the invention are shown in the installed state. The wheel guide rails have a longitudinal extent adapted to the car wash system, as indicated in FIG. 4 as an example. The wheel guide rails according to the invention have mounting means not shown in the drawings, for example, drilled holes in the regions of their bases, wherein they can be screwed onto the floor of the washing system by means of these holes. A direction of travel F of a vehicle to be washed in the car wash system runs perpendicular to the plane of the drawing of FIG. 6 or 7.

FIG. 6 shows a wheel guide rail 9 that is made from an elongated steel hollow profile. It differs from this in that a machine flank 9d does not enclose a 90° angle with the base 9a that is floor-parallel and co-planar in the installed state and the upper end side 9b, but instead another inclination angle β between the base 9a and machine flank 9d equals, in the present case, 45°. This construction allows the wheel guide rails to be brought into an arbitrary proximity to the travel rails 2, 2′ of the washing gantry 1, 1′ in the case of narrow car wash systems, without having to worry about the risk of the shoe of a person being crushed or becoming stuck. In this way, narrow car wash systems can be provided with wheel guide rails according to the invention where this would otherwise not be possible.

A construction of a wheel guide rail 9 according to the invention and shown in FIG. 6 consists of an elongated hollow profile material made from stable material, here steel. A base 9a and an end side 9b run co-planar and essentially parallel to the floor B of the washing system. A machine flank 9d encloses an inclination angle β of 45° with the base 9a, so that it is inclined toward the travel range 4 and thus away from the travel rail 2 and the gantry post 2 [sic; 1]. Due to the inclined machine flank 9d, narrower car wash systems in which the driving width of the washing gantry cannot be increased or where this is not desired due to the wider washing gantry that would then become necessary can be easily adapted to wider vehicles. The wheel guide rail 9 can be arranged closer to the travel rail 2, without having to maintain the typical and currently stipulated maximum or minimum distances. Also for new constructions of car wash systems in which there is insufficient lateral space for the washing gantry in order to make it wider, this problem is prevented by the wheel guide rail 9 according to the invention.

A wheel guide flank 9c is also inclined from the base 9a toward the end side 9b, but away from the travel range 4. Another inclination angle α between the wheel guide flank 9c and a vertical V running perpendicular to the floor B of the washing system and parallel to the direction of travel F or installed wheel guide rail 9 equals, in the present case, 14°. If the inclination angle α is selected to be steeper than 5° to the vertical V, then there is still the risk that the rim of a vehicle will impact the end side 9b or the edge between the end side 9b and wheel guide flank 9d [sic; 9c] and become damaged in this way. If the inclination is selected to be flatter than 30° to the vertical V, then the driver of an entering vehicle no longer notices driving against or over the wheel guide rail 9, especially in large, heavy vehicles with large tire diameters. In order to reduce damage to the tires when driving against or over the wheel guide rail 9, the edge between the end side 9b and wheel guide rail 9d is rounded.

A construction of the invention shown in FIG. 7 shows a wheel guide rail 10 with the same cross section and material as the wheel guide rail 9 from FIG. 6. In addition, a cover 12 made from an elastic, stable, solid material, here hard rubber, is provided on a wheel guide flank 10c and on an end side 10b, in order to protect the rims from damage when driving against the wheel guide flank. The wheel guide flank 10c further has a measurement opening 10e that also extends through the cover 12 in alignment. In the measurement opening 10e, a distance sensor 11 is mounted on the wheel guide flank 10c and is countersunk into the hollow profile of the wheel guide rail 10. The distance sensor 11 is used to measure the distance to the wheel or to the side of a passing vehicle, as described in detail farther below. The distance sensor 11 is an ultrasonic sensor, but other suitable sensor types, for example, infrared or radar sensors could also be used equally. The distance sensor 16 is connected to a controller of the car wash system by means of connection lines not shown in FIG. 7, with this controller evaluating the measurement signals of this sensor, that is, measured distances. Advantageously, several such distance sensors 11 are arranged distributed over the length of the wheel guide rail 10, preferably in equal intervals. Due to the inclined wheel guide flank 11c, a large measurement window for the distance sensors 11 can be provided in an especially good way, so that the distance sensor 11 can also “see” upward in a very steep angle, which would not be possible for a perpendicular wheel guide flank.

For a construction of the wheel guide rail according to the invention not shown in the drawings, instead of the steel hollow body shown in FIGS. 6 and 7, a solid material made from hard rubber is used. This is advantageous with respect to production and damage to rims when driving against the wheel guide rail also can be reliably prevented.

FIGS. 4 and 5 show a car wash system with a wheel guide rail according to the invention. The single difference with respect to the car wash system shown in FIGS. 1 and 2 is that, in the embodiment according to FIGS. 4 and 5, a wheel guide rail 10 or 10′ according to FIG. 7 is used, wherein, for reasons of clarity, the cover 12 is not shown. Instead of the wheel guide rail 10 or 10′, the other wheel guide rails according to the invention according to the embodiment according to FIG. 6 can also be used.

As is to be seen, in particular, from FIG. 5, the distance of the wheel guide rail 10 and the travel rail 2 is indeed significantly smaller than the distance shown in FIGS. 1 and 2 between the conventional wheel guide rail 5 and travel rail 2. Nevertheless, due to the inclined machine flank 10d, there is no risk that the shoe of a person, for example, an operating person, can become jammed. This solution is advantageous also for washing systems in which the vehicle must first be driven into the washing system and then the driver must exit the vehicle, in order to start the cleaning process.

Due to the inclined wheel guide flanks 10c, 10c′, the driver of a vehicle moving in the travel range 4 can position his vehicle in the center, without having to worry about damaging the vehicle tires and/or rims if he drives against one of the wheel guide flanks 10c, 10c′.

The function of the distance sensors 11, 11′ shall now be explained with reference to FIGS. 4, 5, and 8. In the wheel guide rails 10, 10′, multiple distance sensors are arranged at equal intervals from each other, wherein distance sensors 11a-11e and 11′a-11′e, respectively, are designated as examples. In order to obtain optimal distances to the treatment assemblies, a vehicle 12 to be washed should stand in the centered target position P* that is defined by the wheel guide rails 10, 10′ laterally by desired distances A*, A′* and towards the front by a desired longitudinal position L*.

While the vehicle 12 is driven in the travel range 4 in the forwards direction Vw of the direction of travel F, all of the distance sensors 11, 11′ measure the distance of the vehicle wheels of the vehicle from the corresponding right or left wheel guide rail 10, 10′. As an example, FIG. 10 [sic; 8] shows the actual distances A and A′ between vehicle tires and wheel guide rail 10, 10′ at the height of the distance sensors 11c and 11′c, respectively. Because it cannot be determined without great effort whether the distance sensors 11, 11′ measure just the distance to the tire, to the wheel, or to the side of the vehicle, a controller of the washing system calculates the difference from the measured distance from the distance sensors 11 of the left wheel guide rail 10 and from the measured distance from the corresponding opposite distance sensor 11′ of the right wheel guide rail 10′. For example, the difference of distance sensors 11′c, 11c in FIG. 10 is zero, because both are the same size. As long as the difference is zero, that is, the measurement distance of both distance sensors 11, 11′ is the same size, the vehicle is located in the desired centered position with respect to the wheel guide rails 10, 10′ within the travel range 4. If the vehicle 12, however, swerves to the right or to the left from this centered position, then the distance to one of the wheel guide rails 10 decreases and the distance to the other wheel guide rail 10′ increases. The measurement distances of opposing distance sensors 11, 11′ become unequal. Here, the controller outputs a direction correction notice on a display of the washing system, wherein this notice reports to the driver that he is too far to one side and must steer in the opposite direction, in order to move the vehicle in the other direction and thus toward the middle. The display could be formed in the shape of two arrows, wherein one points to the right and the other points to the left. The direction in which the driver is to steer the vehicle, in order to reach the centered position again, is indicated by illuminating the corresponding arrow. For example, if the distance A of the left tire to the left wheel guide rail 10 is less than the distance A′ of the right tire to the right wheel guide rail 10′, that is, the vehicle is located too far to the left, then the right arrow is activated, and vice versa. In addition, for the correct, side-centered placement of the vehicle, directional information is output, e.g., an arrow pointing straight ahead, which reports to the driver that he is centered and does not need to steer left or right. In order to prevent a constant back and forth switching between the associated direction correction notices in the case of small deviations caused, among other things, by measurement disturbances in the associated right-side and left-side measurement distances, which would only confuse the driver, in this case the output of the corresponding direction correction notice is suppressed. Only when the difference between the right and left measurement distance reaches outside the tolerance region that can be adjusted by the desired distances A*, A′*, that is, the distance difference increases even more, is the corresponding direction correction notice output.

Likewise, the longitudinal position L of the vehicle 12 can be determined by the distance sensors 11, 11′ of the wheel guide rails 10, 10′, so that a desired longitudinal position L* can be reached. In FIG. 10, the desired longitudinal position L* is reached when the front of the vehicle reaches the height of the distance sensors 11e, 11′e. As long as the distance sensors 11e, 11′e measure no distance, that is, detect no vehicle, it is indicated to the driver by a drive-forward signal that he should drive farther in the forwards direction Vw, e.g., by a green signal light. As soon as the distance sensors 11e, 11′e each measure a distance, that is, the front of the vehicle reaches the distance sensors 11e, 11′e, then it is indicated to the driver by a stop signal that he should stop driving, for example, by a red signal light. If the vehicle is driven past the desired longitudinal position L*, which is advantageously detected by the distance sensors 11f, 11′f, then it is indicated to the driver by a back-up signal that he should drive in reverse until the vehicle clears the distance sensors 11f, 11′f and 11e, 11′e.

Thus, while driving into the system, feedback both on the side position of the vehicle and also on its longitudinal position L can be obtained. In one advantageous construction of the invention, a vehicle position in the travel range 4 is determined from the measurement distances, with this position being indicated relative to the desired position P* of the vehicle 12. For example, for the desired position P*, the rectangle shown with dashed lines in FIG. 10 can be shown in a display on which the currently measured position of the vehicle 12 is simultaneously and continuously displayed. The driver thus sees how the vehicle is positioned relative to the desired position P* and in which direction he must steer or drive, in order to bring the vehicle into the desired position P*. As soon as the vehicle 12 is in the desired position P*, corresponding information can be shown on the display, for example, a blinking of the displayed desired position P* and vehicle position. An alternative and advantageous display would be to show the displayed vehicle position in red until reaching the desired position P* and then showing the displayed vehicle position in green.

In this way, a method for the centered positioning of a vehicle in a travel range of a car wash system according to the invention is advantageously made possible that is characterized by the following steps: a) two-sided measurement of the distance between the wheel guide rails and wheels and/or vehicle sides of the vehicle while the vehicle is driven into the travel range, b) comparison of the left measurement distance measured from the left wheel guide rail with the right measurement distance measured from the right wheel guide rail, c) output of a first direction correction notice if the measured right distance is greater than the left measured distance, or d) output of a second direction correction notice if the left measurement distance is greater than the right measurement distance. If there is a difference between the right and left measurement distance that is less than a specified tolerance range, no direction correction notice and/or a direction notice can be advantageously output in step c) or step d). In this way, the driver is not confused by frequently changing direction correction notices or it is indicated that the vehicle is positioned centered in the travel range and he does not have to counter-steer.

The distances between the wheel guide rails and wheels and/or vehicle sides are advantageously measured by the distance sensors in the wheel guide rails. In one advantageous refinement of the method, a longitudinal position of the vehicle is determined from the measured distances. In particular, if several distance sensors are distributed across the length of the wheel guide rails, then it can be detected whether a vehicle has driven past a distance sensor or not. In this way, information on the longitudinal position in the washing system is also provided, in addition to the side distance of the vehicle. Advantageously, this information can be used to output a drive-forward signal if the vehicle has not yet reached a specified longitudinal position and/or to output a stop signal if the vehicle has reached the specified longitudinal position, and/or to output a back-up signal if the vehicle has driven past the specified longitudinal position. In this way, the vehicle can be brought into a desired position with respect to the washing system and the treatment assemblies, without having to manage additional measurement effort.

Due to the arrangement of several distance sensors along the length of the wheel guide rail, additional information can be advantageously provided on the longitudinal position of the vehicle relative to the machine, for example, the washing gantry, while driving the vehicle into the system. This information can be made visual accordingly for the driver. In this way, while driving the vehicle into the system, feedback can be provided on the side position of the vehicle and also on the longitudinal position. By means of suitable visualization, the vehicle could be stopped in a target rectangle. If the vehicle is positioned completely within the rectangle, then it is positioned correctly in the longitudinal and transverse axes. If the vehicle is positioned partially outside the rectangle, then it is positioned incorrectly in the longitudinal or transverse axis.

1-15. (canceled)

16. Car wash system with treatment devices (1, 1′, 3, 3′) that can move along a direction of travel (F) for a vehicle to be treated, with a pair of wheel guide rails (9; 10, 10′) running on the floor (B) of the washing system between the treatment devices (1, 1′, 3, 3′) in the direction of travel (F) and arranged spaced apart from each other perpendicular to the direction of travel (F) and laterally defining a travel range (4) for the vehicle, wherein the wheel guide rails (9; 10, 10′) each have a machine flank (9d; 10d, 10d′) pointing upward from a floor (B) of the washing system in the installed state and running along the direction of travel (F) of the vehicle to be treated and pointing away from the travel range (4), wherein the machine flank (9d; 10d, 10d′) is constructed so that it is inclined upwards toward the travel range (4).

17. Car wash system according to claim 16, wherein an inclination angle (β) inclined toward the travel range (4) and formed between the machine flank (9d; 10d, 10d′) and the floor (B) of the washing system equals between 25° and 65°.

18. Car wash system according to claim 16, wherein a wheel guide flank (9c; 10c, 10c′) is provided on a side of the wheel guide rail (9; 10) opposite the machine flank (9d; 10d, 10d′), wherein the wheel guide flank (9c; 10c, 10c′) is constructed so that it is inclined upwards away from the travel range (4) in the installed state of the wheel guide rail (9; 10).

19. Car wash system according to claim 18, wherein an additional inclination angle (α) inclined away from the travel range (4) and formed between the wheel guide flank (9c; 10c, 10c′) and a vertical (V) running perpendicular to the floor (B) of the washing system and parallel to the direction of travel (F) equals between 5° and 30°.

20. Car wash system according to claim 16, wherein the wheel guide rail (9; 10) is formed from an elongated hollow profile material.

21. Car wash system according to claim 16, wherein a cover (12) made from plastic or rubber is arranged on the wheel guide flank (10c).

22. Car wash system according to claim 21, wherein the cover runs from the wheel guide flank (10c) farther past an end side (10b) adjacent to the upper end of the wheel guide flank.

23. Car wash system according to claim 16, wherein the wheel guide rail is formed from a solid material made from plastic or hard rubber.

24. Car wash system according to claim 16, wherein at least one distance sensor (11) for measuring the distance from the wheel guide rail (10) to the outside of a wheel and/or to the side of a vehicle is provided in the wheel guide rail (10).

25. Car wash system according to claim 24, wherein the wheel guide flank (10c) has one or more measurement openings (10) spaced apart from each other for holding the distance sensor or sensors (11).

26. Car wash system according to claim 16, wherein the machine flank (9d; 10d, 10d′) is arranged on a side of the wheel guide rail (9; 10) facing away from the travel range (4).

27. Car wash system according to claim 16, wherein the distance of the wheel guide rails (10, 10′) from each other perpendicular to the direction of travel is greater than a specified maximum wheel distance.

28. Car wash system according to claim 16, wherein the wheel guide flanks (10c, 10c′) of the wheel guide rails (10, 10′) point toward the travel range (4).
